(19) United States
(12) Patent Application Publication
(10) Pub. No.: US 2018/0066457 A1
(43) Pub. Date: Mar. 8, 2018

(54) LOCKING DEVICE FOR A VEHICLE DOOR, AND METHOD

(71) Applicant: Magna BÖCO GmbH, Wuppertal (DE)

(72) Inventors: Bernardo Erices, Bergisch Gladbach (DE); Konstantin Krieger, Leverkusen (DE); Uli Maak, Erkrath (DE)

(21) Appl. No.: 15/692,224

(22) Filed: Aug. 31, 2017

(30) Foreign Application Priority Data
Sep. 5, 2016 (DE) 102016010672.7

(51) Int. Cl. E05B 77/12; E05B 79/20; E05B 81/24; E05B 81/04

(52) U.S. Cl. CPC E05B 77/12; E05B 81/04; E05B 81/24; E05B 79/20

(57) ABSTRACT

A locking device for a vehicle door comprising a latch mechanism having a rotary catch which can be arrested by a pawl for trapping a closing element when the vehicle door is closed. The pawl is displaceable via actuation of an electromotive drive unit for the purposes of releasing the rotary catch. A connector for a mechanical opening actuation mechanism of the vehicle door, such as an outside door handle, is provided. The locking device has a coupling element which is actuated via the drive unit to couple the connector to the pawl in the event of a crash being detected by a crash sensor.

### CROSS-REFERENCE TO RELATED APPLICATIONS

This application claims the benefit and priority of German Application No. 102016010672.7, filed Sep. 5, 2016. The entire disclosure of the above application is incorporated herein by reference.

### FIELD

The present disclosure relates generally to a locking device for a vehicle door. More particularly, the locking device of the present invention includes a coupling arrangement operably disposed between a connector associated with a mechanical opening mechanism and a pawl of a latch mechanism and which operates to selectively couple the connector to the pawl in the event that a vehicle crash is detected by a crash sensor.

### BACKGROUND

This section provides background information related to locking mechanisms of the type used in vehicle door closure systems and is not necessarily prior art to the present invention.

A locking device for a vehicle door, in particular for a motor vehicle side door, typically comprises a latch mechanism having a pivotable rotary catch and a pawl which selectively immobilizes the rotary catch. The pawl is typically provided for arresting the rotary catch and can in many cases be moved into a release position both by means of a power-operated drive unit (i.e. electromotively), and manually by means of a handle provided on the inside or outside of the vehicle door.

For some time, efforts have been made to enable the vehicle door to be opened by remote actuation alone, for example from the driver's seat, by means of an electromotive drive unit. The possibility of opening the vehicle door from the outside is in this case basically no longer desired. This may on the one hand be linked to considerations regarding antitheft protection, and may on the other hand also be linked to a trend toward full electrification of the vehicle, for example of a van or of a small bus or of a conventional passenger motor vehicle. On the other hand, in the case of such a desired solution, the problem exists that the vehicle electronics can fail in the event of a crash. In this case, it would then no longer be possible for the vehicle door to be opened from the outside at all, which generally opposes safety considerations.

### SUMMARY

This section provides a general summary of the present invention and is not considered a comprehensive and exhaustive listing of all of its embodiments, its full scope or its features.

It is therefore an object of the present invention to improve the redundancy of a locking device, in particular after an accident situation.

The present invention achieves this object, according to a first aspect, by means of the features of claim 1, and is accordingly characterized in that the locking device has a coupling element which couples a connector associated with a mechanical opening actuation means to a pawl associated with a latch mechanism in the event of a crash being detected by a crash sensor which can be assigned to the locking device.

In other words, the inventive concept of the present invention is directed to allowing the mechanical opening actuation means to displace the pawl only when a crash situation has been detected. In an accident situation, the mechanical opening actuation means of the vehicle door can thus be manually actuated, and in this way the pawl can be displaced for releasing the rotary catch. This is not possible before an accident situation occurs. Typically, in this case, the connector for the mechanical opening actuation means runs into a free space or the like.

For this purpose, for example, a type of switch may be provided which can actuate the pawl in a manner controlled by a drive unit for as long as no accident has occurred, which switch can then be “switched over” in the event of an accident situation being detected, such that the coupling element shifts, is displaced or is activated (in manner controlled by a drive).

The coupling element may, for example, act on the pawl (and displace the latter), directly or indirectly, specifically for example via a gearing or a linkage or the like. For this purpose, a pawl lever which cooperates with the pawl is provided, which pawl lever can adjust the pawl (by means of one end thereof) and, on the other hand, in an accident situation (after coupling by means of the coupling element), can interact with the connector for the mechanical opening actuation means (for example at an opposite end).

For this purpose, the coupling element may be formed as a lever which has one or more arms. By means of one of the arms, the coupling element may for example interact with the pawl, or preferably initially with a pawl lever.

In a coupled state, the coupling of the connector to the pawl is realized such that a manual actuation of the mechanical opening actuation means leads to an actuation or a pivoting-out movement of the pawl, preferably into a release position. In a decoupled state of the connector and the pawl, this is not the case, and the pawl would not be displaced even in the event of an actuation of the mechanical opening actuation means of the vehicle door (owing to the decoupling).

Here, the coupling operation is typically performed automatically, specifically when a crash sensor detects a crash. For this purpose, the crash sensor can typically transmit a signal to the locking device (indirectly or directly, as will be described in more detail further below) and, accordingly, ensure coupling of the pawl and the connector.

The crash sensor is, for this purpose, typically arranged remote from the locking device, for example, in the front-end region of the vehicle. The crash sensor may be a crash sensor such as is also utilized for triggering other functions of the vehicle such as, for example, for triggering the airbags or the like.

The crash sensor may in particular also be connected to a controller which then transmits the signal to the locking device, for example, in the form of control information for the drive unit or the like (for example, an electric motor may, for this purpose, be driven in the event of a crash being detected). Here, the signal transmission should take place immediately after the detection of the crash, because in practice, it may be the case that the entire on-board electronic system of the vehicle is deactivated, or rendered non-functional, by the crash itself. Therefore, the coupling function can then still be performed beforehand, which coupling is thus triggered by the signal of the crash sensor (or of the controller).

The crash sensor of the vehicle is assigned to the locking device which means, in particular, that the crash sensor is capable of transmitting a signal to the locking device, for example via a controller. The crash sensor thus need not be arranged geometrically directly at the locking device, but rather is typically—as already stated—arranged remote from the locking device on the vehicle but connected to the locking device in some way. This need not involve a physical connection, but rather merely an information connection. For example, the crash sensor or the controller may also transmit a signal to the locking device wirelessly or in similar fashion. On the other hand, the crash sensor may however also be connected to the locking device, in particular, to the drive thereof, in particular via a controller, by cable or the like.

During or after a crash situation, the coupling element will ensure that the connector for a mechanical opening actuation means of the vehicle door is coupled to the pawl. The connector may, for example, be a Bowden cable which may be connected in particular to an outside door handle. A connector may also be understood to mean the attachment for the Bowden cable to the locking device, if the Bowden cable is not intended to be part of the locking device and is for example manufactured separately from the locking device. The attachment may in this case typically be mounted movably in a (partially open) housing (which, in one embodiment, is of pivoted form).

It is essential here that, in the decoupled state, the operative chain between the opening actuation means (that is to say for example the vehicle's outside handle) and the pawl is interrupted. The operative chain may then be enabled by means of a displacement of the coupling element. This thus has the effect that, during conventional use of the vehicle, an outside door handle, despite being actuated, typically does not lead to the opening of the locking device. It does, however, after an accident situation has occurred. Thus, in an accident situation, access from the outside can be permitted for the purposes of assistance.

Here, the coupling element may actively or passively ensure a coupling between the pawl and the connector, for example, by producing a type of connection or by being moved out of the way in order to allow or permit such a connection or operative chain.

As in the prior art, the locking device according to the invention can, during conventional use of the vehicle, that is to say before an accident situation has occurred, be opened or unlocked at any rate by means of a drive unit, in particular by means of an electric drive or an electric motor.

For this purpose, the drive unit may, for the purposes of releasing the rotary catch, act on the pawl and transfer the latter into a release position. The drive unit may for example do this directly (and act directly on the pawl). A variant is however indeed preferable in which the drive unit acts initially on a gearing, for example a pawl lever or the like, which then cooperates with and can displace the pawl.

In addition to the pawl lever, it is also possible for further elements, such as for example a drive wheel, output wheel or the like, to be provided between the drive unit and the pawl. This element may for example permit a transmission of the rotational movement of an electric motor to the pawl or to the pawl lever. At any rate, the drive unit can be operated or activated in order to release the rotary catch.

This is typically performed by means of a central vehicle controller to which, in particular, the crash sensor may also be connected. The controller will in this case typically also predefine a primary direction of rotation for the drive unit, at any rate if the drive unit is an electromotive drive. A secondary direction of rotation may then be predefined in an accident situation or in a crash situation. The electromotive drive unit is in this case typically a constituent part of the locking device.

Here, an opening process of the locking device can thus be performed by means of an actuation or activation of the drive unit. This is typically triggered by remote control, that is to say remotely from the locking device, for example by means of a button or switch in the cockpit of the vehicle or by means of a non-mechanical actuation device at some other location.

During such an opening process, the rotary catch (which is released after movement of the pawl into its release position) will normally release a closing element, which is held trapped by the rotary catch when the vehicle door is closed. A closing element of this type may for example be a limb of a striker or a closing bolt or the like, which is furthermore typically arranged on the vehicle body. The locking device itself is, by contrast, typically arranged on the vehicle door. However, a reversed arrangement is also readily possible.

A corresponding vehicle door may, for example, be a motor vehicle side door, in particular a sliding door, such as is known for example from small buses for passenger transport, box-type trucks or the like. The expression “vehicle door” however basically also encompasses flaps, such as tailgate flaps or front flaps or the like.

In a preferred embodiment of the invention, the locking device has means for implementing a signal from the crash sensor, which means can act on the coupling element. Such means may for example be the drive unit, which may, for example, be formed as an electric motor and which can rotate in a different direction after receiving a signal than before the receipt of the signal.

The means may however also comprise other or further elements, such as for example a drive wheel, an output wheel, a switch lever or the like. At any rate, such means must be capable of acting on the coupling element in order to adjust the coupling element. A coupling of the connector and the pawl can then be realized by means of the adjustment of the coupling element.

The drive unit is typically connected to the controller (for example by cable or wirelessly), wherein the controller receives the signal from the crash sensor and takes the signal into consideration in the drive control thereof. The means can then, in such a situation and upon receipt of such a signal, act on the coupling element.

The coupling element may, for example, be displaced or pivoted from a passive position into an active position. In the passive position, the pawl is decoupled from the connector, and in the active position, a coupling has then taken place. Alternatively, a reversal of this approach is also possible: accordingly, in an active position of the coupling element, a decoupled state of the pawl and the connector may exist (for example because the connector is blocked or disengaged, deflected or the like by the coupling element), and a coupled state may then exist in a passive position (in which the coupling element has for example then been adjusted out of the way).

In a particularly advantageous embodiment of the invention, the coupling element is adjustable by exactly the same drive unit as that which acts indirectly or directly on the pawl, for the purposes of releasing the rotary catch, in a non-accident situation. In this way, a dual functionality can be realized by means of a single drive unit. First, the drive unit must on the one hand be provided in any case, because it serves for a conventional opening of the locking device. Secondly, the drive unit may also initiate a coupling of the connector and pawl. For this purpose, the drive unit may for example be formed as an electric motor and have two different directions of rotation, in each case one for one of the two functions. The drive unit may in this case preferably interact with a drive wheel or a switch element or the like in order to achieve said dual functionality.

In a further advantageous embodiment of the invention, in the event of an activation of the mechanical opening actuation means, the connector runs into a free space if, or for as long as, the connector and the pawl are still decoupled. In other words, the opening actuation means may be, for example, manually actuated, that is to say for example a handle may be pulled, which handle displaces a Bowden cable with a pulling bolt, which pulling bolt runs into the free space.

An alternative embodiment would be a locking device in which, in such a situation, the connector is blocked entirely. It is however more advantageous if the connector, as described, runs into the free space because the risk of material damage or the like is minimized.

For example, a vehicle user can manually pull on an outside door handle, which leads to a displacement of a Bowden cable. The end of the Bowden cable however runs into a free space and thus does not activate the pawl, for as long as the pawl and the connector are still decoupled. Here, the coupling element may advantageously remain in its passive position and be moved into its active position when the running into the free space has ended, specifically after detection of an accident situation.

In another refinement, the coupling element may however also be situated in an active position when the connector runs into the free space because the coupling element, for example, actively deflects or disengages the connector such that the latter cannot enter into engagement with the pawl or with a lever or the like assigned to the pawl.

The drive unit advantageously acts on a switch element which is formed in particular as a drive wheel or output wheel. Here, the switch element has a first (contact) surface and a second (actuation) surface. The first surface is, in this case, utilized for acting on the pawl for the purposes of releasing the rotary catch and may, for example, actuate the pawl directly or indirectly via a gearing such as, for example, a pawl lever or the like. It is very preferably possible for the first surface to be formed in the manner of an eccentric which permits a very reliable actuation of the pawl. The second surface is then utilized, in the event of an accident situation being detected, to act on the coupling element and adjust the latter from its active position into its passive position or vice versa. Here, the second surface may typically be arranged opposite the first surface, for example, on the opposite side of a drive wheel. The second surface may however also be arranged for example on the same eccentric cam as the first surface, but provided for example by a flat side situated opposite the eccentric surface on the eccentric cam.

If the first contact surface and the second actuation surface are arranged on opposite sides of a drive wheel, it is preferred if the two surfaces are also arranged in offset planes, in particular in relation to the spindle of the drive wheel or in relation to the spindle of an electric motor. In a first plane, the first contact surface may then act (indirectly) on the pawl in the conventional manner. In the second plane, the second actuation surface may then, in the event of an accident situation being detected, act indirectly or directly on the coupling element (for example a control lever) for the purposes of adjusting the latter.

In the most preferred embodiment of the invention, the coupling element is assigned a connecting piece which is adjustable by the coupling element into the opening travel of the connector for the purposes of coupling the connector and the pawl. The connecting piece may in this case ensure that the connector, when actuated, can act (indirectly) on the pawl for the purposes of releasing the rotary catch. The connecting piece can thus increase the range of action of the connector and thus connect the connector to the pawl or to a gearing element assigned to the pawl such as, for example, a pawl lever. In other words, the movement range of the connector is also increased by means of the connecting piece. Whereas the connector otherwise runs into a free space when actuated, it can, as a result of the elongation of the connecting piece, actually act on the pawl or the pawl lever (and in this case reach the pawl or the pawl lever). In the pulling direction, the connecting piece may be arranged between (an end of) the connector and the pawl or a pawl lever.

Here, the connecting piece may be arranged movably on the coupling element, for example in linearly displaceable fashion. The connecting piece may thus for example be linearly displaceable on a lever arm of a coupling element formed as a control lever, and may be formed in particular as a sliding block. The sliding block may be preloaded into a defined initial position by a spring and then engaged behind by the connector in an active position of the control lever.

In an alternative embodiment of the invention, the coupling element interrupts the operative chain between the connector and the pawl in a first position (or active position). The coupling element can then be adjusted away into a second position (or passive position). In this way, too, a coupling of the connector and the pawl can be achieved. For example, the coupling element may, in the first position, deflect the connector. If the coupling element is then transferred or adjusted away into the second or passive position, the connector can engage. It is thus possible, for example, for a Bowden cable to pass into a position of engagement with the pawl (directly or preferably indirectly, for example into engagement with a pawl lever connected upstream of the pawl). For this purpose, the coupling element is thus adjusted out of the way in a simple manner, whereby the connector and the pawl are coupled. This adjustment out of the way may typically be performed by means of the switch element, in particular an output wheel.

Alternatively, in this exemplary embodiment, a blocking of the connector may also be performed instead of a deflection. For example, the Bowden cable may be blocked by means of the coupling element such that the Bowden cable is no longer activatable at all. If the coupling element is then adjusted away into its passive position, the connector is released (without it having to engage), and the connector is thus coupled, at any rate indirectly, to the pawl.

In both of the latter alternatives, it is however always the case that the coupling element is adjusted out of the way, from its active position into its passive position. In this way, the operative chain between connector and the pawl is, in each case, closed which operative chain leads from the connector to the pawl either directly or via an interposed gearing, for example in the form of a pawl lever.

In a particularly advantageous refinement of the invention, the coupling element is formed as a lever which has two detent positions. The detent positions may in this case advantageously correspond to the passive position and the active position of the coupling element, such that the lever can engage with detent action in both positions. Typically, no further intermediate detent positions exist between the active position and the passive position, such that a secure arresting action is possible only in one of the two predefined positions. The first position is assumed when an accident situation has not yet been detected. In the event of the accident situation being detected, the lever can then be disengaged, and engaged with detent action in its second position.

Such an embodiment permits an easier subsequent resetting of the locking device, for example in a workshop. It is thus possible for the coupling element formed as a lever to then be easily returned from the second detent position into the first detent position in the workshop in a mechanically simple manner, for example with the aid of a screwdriver or the like. The detent positions may be realized, for example, by means of detent balls or the like, wherein, for example, a preloaded ball may be arranged on the underside of the lever and then receptacles for the detent balls may be arranged in each case on the vehicle body or on the door at the two detent positions. Any other form of detent arrangement is also conceivable.

Here, the coupling element preferably has at least two lever arms, wherein a first lever arm can be utilized for acting on the coupling element and a second lever arm can be utilized for acting on the pawl. It is also possible for more than two lever arms to be provided. In an alternative embodiment, the coupling element is formed merely as a one-armed lever which is preferably mounted at one end thereof on a pivot spindle on the vehicle body or on the door and which, by means of the other end, can interact with, for example deflect or block, the connector.

According to a further aspect of the invention, the present object is achieved by means of a method according to claim 10. The method is in this case characterized in particular by the following steps:
detection of an accident situation by means of a crash sensor;
transmission of a signal from the crash sensor, at any rate indirectly, to the locking device;
resulting triggering of a coupling element;
coupling of the connector to the pawl by means of the triggered coupling element; and
manual triggering of the mechanical opening actuation means for the purposes of displacing the pawl to release the rotary catch.

It is pointed out that, before a detection, the connector is actually displaced in the locking device, but does not trigger any function, and in particular does not displace the pawl if the mechanical actuation means is actuated.

At this juncture, it is pointed out that not all of the above-stated advantageous embodiments or observations will be repeated in conjunction with the method of claim 10. This is omitted for the sake of expediency and for conciseness of the application.

It is however self-evidently intended for all of the advantages and descriptions to also apply to the method of claim 10. It is thus the intention for the disclosure to be regarded as encompassing method steps by which the coupling element is adjusted by the drive unit, by which the two states of the drive unit correspond to the directions of rotation of an electric motor, for which purpose the electric motor is movable in a first direction of rotation for the actuation of the pawl and in a second direction of rotation for the adjustment of the coupling element, etc. This is merely exemplary.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

In the Figures:

FIG. 1 shows a highly schematic, isometric illustration of a locking device according to a first exemplary embodiment of the invention and operating in a decoupled state with an arrested rotary catch;

FIG. 2 shows the locking device in a view similar to FIG. 1 but now operating in a coupled state;

FIG. 3 shows the locking device in a view similar to FIG. 2 with an actuated Bowden cable and a released rotary catch;

FIG. 4 shows a detail from the locking device of FIG. 1 in a rear view, approximately in the direction of arrow IV in FIG. 1;

FIG. 5 shows a highly schematic plan view of a motor vehicle in which the locking device according to the present invention is arranged to lock a sliding side door;

FIG. 6 shows a second exemplary embodiment of a locking device according to the present invention in a highly schematic plan view operating in a decoupled state;

FIG. 7 shows a lateral, partially sectional diagrammatic illustration of a decoupled state of the connector and the pawl, taken approximately along arrow VII in FIG. 6;

FIG. 8 shows the locking device in a view similar to FIG. 6, with the coupling element having been disengaged by means of an output wheel;

FIG. 9 shows the locking device in a view similar to FIG. 8, with the output wheel having been rotated back into a coupling position; and

FIG. 10 shows a detail as per FIG. 7 in a coupled state of the connector and the pawl.

It should first of all be noted that in the following figure description, identical or similar parts are denoted where appropriate by identical reference designations, in part with the addition of lowercase alphabetic characters or apostrophes. In the patent claims that follow the figure description, the reference designations used in the figures and in the figure description are thus, for the sake of simplicity, used where appropriate (in part) without apostrophes or lowercase alphabetic characters, if the corresponding subjects are similar.

### DETAILED DESCRIPTION

Example embodiments of a locking device for a motor vehicle door will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

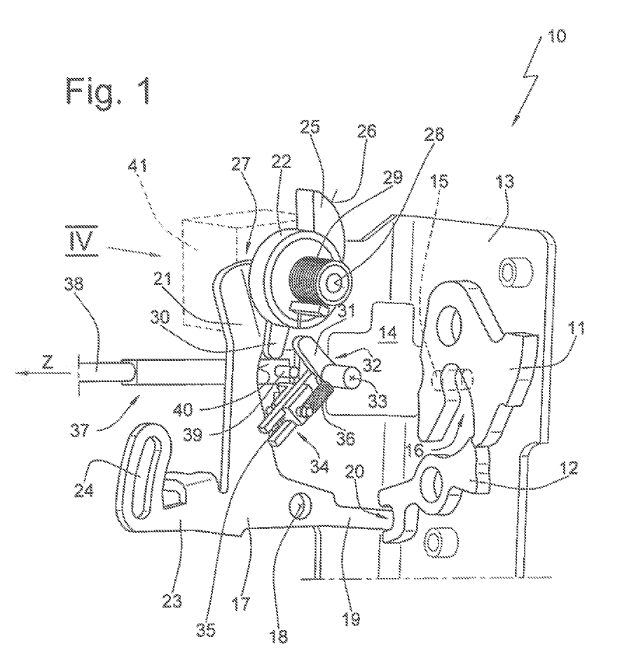

A first exemplary embodiment of a locking device 10 for a vehicle door constructed according to the present invention is illustrated in FIG. 1. In FIG. 1, a latch mechanism is shown to include a rotary catch 11 arrested by a pawl 12. Both are arranged pivotably, by means of spindles (not illustrated), on a housing or a mounting plate 13. Here, the mounting plate 13 has an opening 14 through which a closing element 15 (illustrated merely by dashed lines in FIG. 1) can exit the locking device 10 for the opening of the vehicle door. In FIG. 1, the closing element 15 is however still trapped in jaw 16 of the rotary catch 11 and is also held securely there as a result of the arresting action by means of the pawl 12 in an arresting position holding the rotary catch 11 in a closed position. The housing or the mounting plate 13 (with rotary catch 11 and pawl 12) is typically arranged on the vehicle door, and the closing element 15 is typically arranged on a vehicle body. It is however also possible for this arrangement to be reversed.

As shown in FIG. 1, the pawl 12 may be actuable by a pawl lever 17 which is likewise pivotably fastened to the mounting plate 13 by means of a spindle 18 (not shown in any more detail). In the exemplary embodiment, the pawl lever 17 is arranged at approximately a 90 degree angle relative to the pawl 12 and the rotary catch 11 and has a first arm 19 with a pawl lever end retained in a pawl jaw 20 of the pawl 12 in order to be able to move the latter, in particular from its arresting position into a releasing position (not illustrated in FIG. 1). Movement of pawl lever 17 from a home position (shown in FIG. 1) to an actuated position about pivot spindle 18 results in movement of pawl 12 from its arresting position to its releasing position which, in turn, permits rotary catch 11 to pivot from its closed position to an open position.

The pawl lever 17 has a second arm, a so-called actuation arm 21, through which the pawl lever 17 can be actuated by a switch element, which in the present exemplary embodiment is configured as a drive wheel 22. Finally, FIG. 1 also shows a third arm 23 formed on the pawl lever 17. The third arm 23 however serves merely for guidance (or possibly emergency actuation or the like). For this purpose, it is possible for a fixedly arranged peg or the like to engage (not illustrated) into the elongated hole 24 provided on the third arm 23 from its home position into its actuated position.

For actuation of the actuation arm 21 on pawl lever 17, the drive wheel 22 has a first arm which, in the exemplary embodiment, is formed as an eccentric cam 25. Here, the eccentric cam 25 forms an eccentric-like contact surface 26 which is arranged substantially in the plane of an actuation surface 27 formed on the actuation arm 21 of the pawl lever 17. The actuation surface 27 is concealed in the illustration in FIG. 1 and projects from the rest of the pawl lever 17. For actuation of the pawl lever 17, the drive wheel 22 may pivot about its pivot spindle 28 through approximately 270 degrees clockwise with regard to FIG. 1. Furthermore, the pivot spindle 28 is assigned a spring element 29 which preloads the drive wheel 22 into its initial position illustrated in FIG. 1 (and functions to return the drive wheel 22 into its initial position after the drive unit 41 has completed the actuation), in particular from both directions of rotation. Here, the pivot spindle 28 is advantageously likewise arranged on the mounting plate 13.

Aside from the eccentric cam 25, the drive wheel 22 also has a second arm, specifically a contact cam 30, which, with regard to its radial orientation, is arranged on the drive wheel 22 opposite the eccentric cam 25. Furthermore, the contact cam 30 is arranged on the drive wheel 22 so as to be axially offset with respect to the eccentric cam 25, that is to say is arranged not in the plane of the actuation surface 27 of the pawl lever 17 but rather in the plane of a changeover arm 31 of a coupling element 32. In the exemplary embodiment, the coupling element 32 is designed as a two-armed coupling lever and is pivotable about a pivot spindle 33, basically clockwise with regard to FIG. 1. Here, the pivot spindle 33 is arranged on the mounting plate 13. As can be seen in FIG. 1, the coupling element 32 also has a second arm, a coupling arm 34, in addition to the changeover arm 31. The coupling arm 34 is basically formed as a linear guide and guides a sliding block 35 which is formed and movable, in particular linearly adjustable, on the coupling arm 34. The sliding block 35 is preloaded toward the spindle 33, specifically by means of a spring element 36. The sliding block 35 is thus situated in a retracted position. It should also be noted that the coupling element 32 is locked with a detent action in the position illustrated in FIG. 1 by means of detent elements (not illustrated). For example, different detent ball positions or the like may be provided in the region of the spindle 33.

In a position as per FIG. 1, the coupling element 32 has not yet been placed in engagement with, or has not yet been engaged behind, a connector 37 that is connected to mechanical opening actuation means or mechanism. The connector 37 is provided by an end or attachment portion of a Bowden cable 38, which in the drawings is partially concealed by a housing part. At its non-illustrated end, the Bowden cable 38 connects to a manually-actuatable component of the mechanical opening actuation means. This manually-actuatable component of the mechanical opening actuation means may preferably be the outside handle of the vehicle door.

It can also be seen in FIG. 1 that the connector 37 has a pulling bolt 39 which, when the Bowden cable 38 is actuated by means of the outside handle (not illustrated), is displaceable basically in the pulling direction Z. The range of movement of the pulling bolt 39 is however restricted such that, in the event of an activation of the outside handle, and in a state of the locking device 10 as illustrated in FIG. 1 (decoupled state), the pulling bolt 39 does not strike an auxiliary surface 40 formed on the second leg 21 of the pawl lever 17. In the event of an actuation of the Bowden cable 38 in the pulling direction Z, the connector 37 and the pulling bolt 39 would run into a free space, at any rate in a position of the locking device 10 as per FIG. 1.

In a position of the coupling lever 32 as per FIG. 1, however, the pawl lever 17 and thus also the pawl 12 are still indeed actuable, not manually by means of actuating the Bowden cable 38, but rather by means of the drive unit 41 indicated merely by dashed lines in FIG. 1. The drive unit 41 may typically be in the form of an electric motor. The drive unit 41 is coupled to the spindle 28 of the drive wheel 22 and can pivot the latter clockwise with regard to FIG. 1, in particular to such an extent that the eccentric cam 25 presses with its contact surface 26 against the actuation surface 27 of the pawl lever 17 and can thus pivot the pawl lever 17 counterclockwise with regard to FIG. 1 from its home position into its actuated position. This pivotal movement of the pawl lever 17 from its home position to its actuated position then leads to the transfer or movement of the pawl 12 from its arresting position into its releasing position (not illustrated) which in turn, releases the rotary catch 11 for movement from its closed position to its open position. For this purpose, the eccentric cam 25 will—as already discussed above—be pivoted through approximately 270 degrees. For this purpose, the drive unit 41 will rotate in a first direction of rotation, also referred to as the actuation direction, which corresponds approximately to the clockwise direction with regard to FIG. 1 (and subsequently, the spring element 29 can return the drive wheel 22 from its actuated position into its initial position).

For this purpose, the drive unit 41 may be operated by a central controller of the vehicle 42, as is purely schematically denoted for example in FIG. 5 by the reference designation 43. The controller 43 may in this case be connected to the merely schematically illustrated locking device 10, for example via a line 44 (or else wirelessly or in similar fashion). The locking device 10 is in this case arranged in the region of vehicle door 45, which in the present case is in the form of a sliding door. The vehicle door 45 has an outside handle 46, which is illustrated on an enlarged scale and schematically and which is connected in particular to the Bowden cable 38 illustrated in FIG. 1.

With regard to FIG. 5, it is pointed out that the layout of the line 44 is merely a highly schematic depiction. In particular if the locking device 10 is arranged on the door 45 and not on the vehicle body, the line will in this case possibly run differently, or else a connection will be produced between the controller 43 and locking device 10 without the use of a line. FIG. 5 also illustrates that the controller 43 is also connected to a crash sensor 47. The crash sensor 47 is arranged in the front-end region of the vehicle 42, for example in the region of a bumper or the like, and can detect an imminent or occurring crash. A corresponding detection of a crash can then be transmitted by the crash sensor 47 to the central controller 43 by means of a signal via the illustrated line 48.

The crash sensor 47 may typically also be the sensor which serves for detecting the crash before the deployment of airbags. The triggering of the airbags is in this case generally also performed by the controller 43, which typically also ensures that the complete on-board electronic system of the entire vehicle 42 is deactivated, after a certain initial time period, in an accident situation. In the case of the locking device 10 according to the invention as per FIG. 1, this would however have the effect that, after this initial time period, the drive unit 41 could no longer lead to the displacement of the pawl lever 17, and thus to the release of the rotary catch 11.

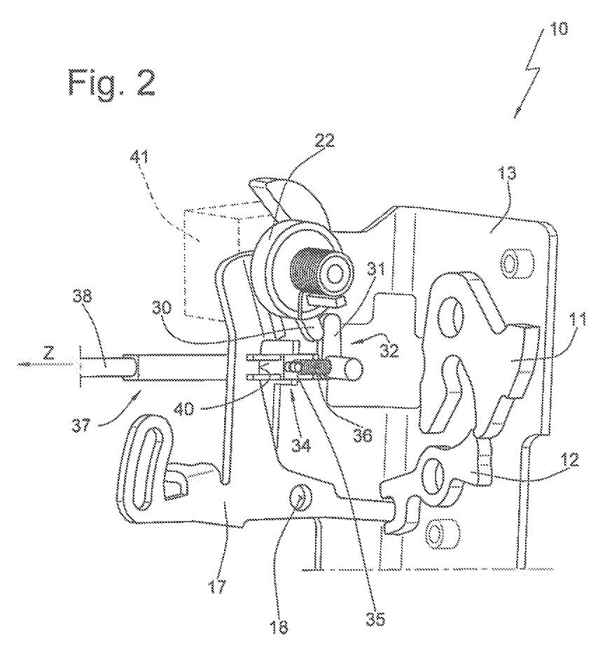

Therefore, in the exemplary embodiment as per FIG. 1, there is the special feature that the drive unit 41 can rotate not only in its actuation direction (that is to say clockwise with regard to FIG. 1), but rather its direction of rotation is also reversible, in particular by means of a signal from the controller 43. In a crash situation, the controller 43 can thus trigger the drive unit 41 (before the on-board electronic system is deactivated) to rotate in its secondary direction (that is to say counterclockwise with regard to FIG. 1). This self-evidently has the effect that the drive wheel 22 also rotates counterclockwise with regard to FIG. 1. Since the changeover arm 31 of the coupling element 32 and the contact cam 30 of the drive wheel 22 are arranged in the same plane, such a rotational movement of the drive wheel 22 leads to a disengagement of the coupling element 32 from its first detent position or uncoupling position (“passive” position) illustrated in FIG. 1 and to a transfer or movement of the coupling element 32 (by means of a pivoting movement clockwise with regard to FIGS. 1 to 3) into a second detent position or coupling position (an “active” position) illustrated in FIG. 2.

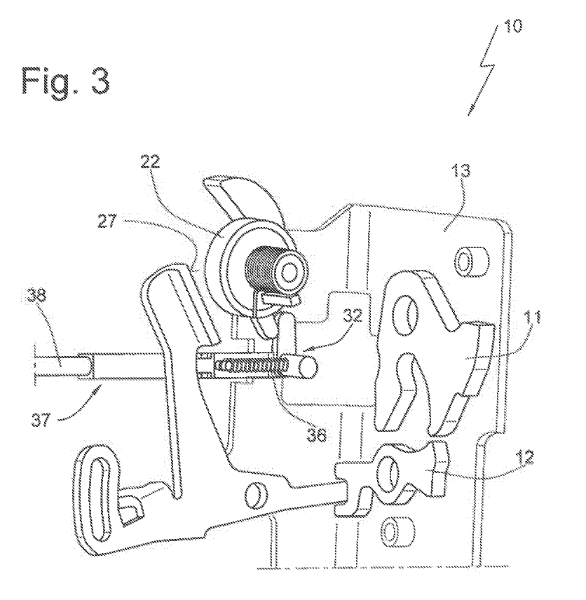

FIG. 2 illustrates this second detent position of the coupling element 32, in which the contact cam 30 still bears against the changeover arm 31 of the coupling element 32 but moves no further clockwise with regard to FIG. 2. Rather, after the defined position of the drive wheel 22 as per FIG. 2 is reached, the drive unit 41 is then also stopped and, in particular in an accident situation, is deactivated entirely, preferably as a result of the deactivation of the on-board electronic system. In practice, the spring element 29 preferably ensures a direct return movement of the drive wheel 22 into the initial position as per FIG. 1 (even if this is achieved differently in the present exemplary embodiment as per FIG. 3).

Consequently, the coupling element 32 is however situated in its coupling position and is locked there with detent action (by the stated detent means, which are not illustrated). In this position, illustrated in FIG. 2, the sliding block 35 engages behind the pulling bolt 39, which is illustrated in FIG. 1 but which is concealed in FIG. 2, of the connector 37. For this purpose, the sliding block 35 may have an engage-behind surface described in more detail further below, which engage-behind surface is however situated on that side of the sliding block 35 which is averted from the viewer with regard to FIG. 2. Consequently, the coupling element 32 or the sliding block 35 is however now situated in the pulling path of the connector 37 in the pulling direction Z.

This has the effect that actuation of the outside handle 46 illustrated in FIG. 5 no longer results, via the Bowden cable 38, in the connector 37 and pulling bolt 39 running into the free space. Rather, the pulling bolt 39, which is not illustrated in FIG. 2, now acts on the sliding block 35 and displaces the latter in the pulling direction Z within the guide on the coupling arm 34 and counter to the force of the spring element 36, to the left with regard to FIG. 2. Here, the sliding block 35 comes into contact with the auxiliary surface 40 on the pawl lever 17, such that the pawl lever 17 can pivot about its pivot spindle 18 from its home position toward its actuated position, counterclockwise with regard to FIG. 2. This then leads, as shown in FIG. 3, to a pivoting movement of the pawl 12 clockwise with regard to FIGS. 2 and 3 into its releasing position illustrated in FIG. 3, in which, in particular, the rotary catch 11 is released. The rotary catch 11, which is no longer arrested, can then move to its open position and release the closing element 15, which is no longer illustrated in FIGS. 2 and 3. The closing element 15 can pass out of the opening 14, for which purpose the rotary catch 11 would typically pivot, in particular under preload, clockwise with regard to FIG. 3 to its open position. Finally, FIG. 3 also again visually shows the deflection of the spring element 36. However, for the sake of clarity, it is not taken into consideration in said figure that the drive wheel 22 would actually have already been returned into its initial position by the spring element 29.

The locking device 10 thus permits a “coupled” connection of an outside door handle 46 to the pawl 12 in a simple manner in an accident situation and after a crash sensor 47 has detected a crash situation. Such a connection or operative chain cannot be utilized during normal use of the vehicle 42, that is to say before the detection of a crash, because the operative chain is “uncoupled” or interrupted. It is the coupling element 32, in conjunction with the switch element 22 and the corresponding actuation of the drive unit 41, that first permits such coupling.

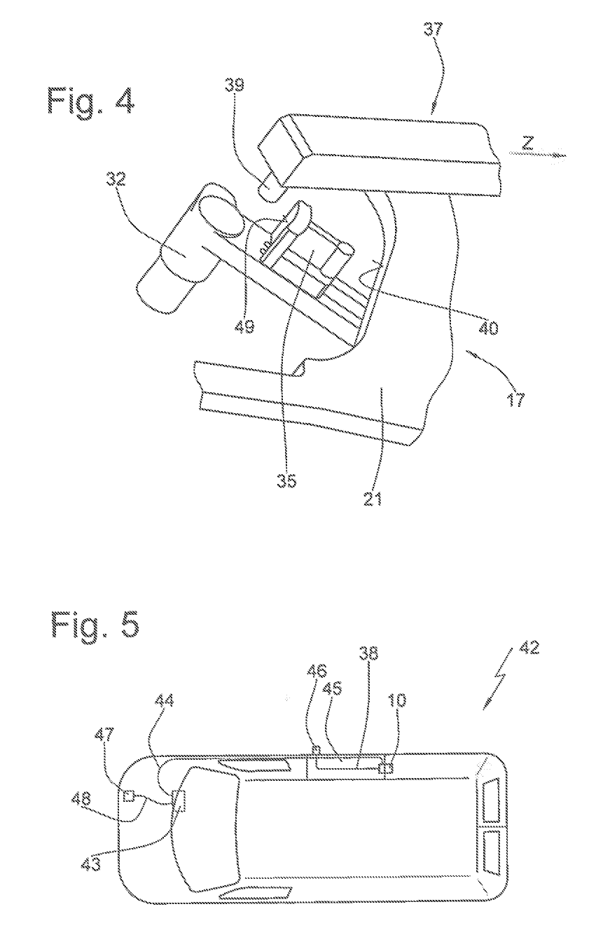

With regard to the first exemplary embodiment, reference is finally made to FIG. 4, which shows an enlarged illustration of a detail of the rear side of some components originally shown in to FIG. 1. Here, it can be seen that the sliding block 35 has, on its side facing toward the connector 37, a pulling surface 49 which can interact with the pulling bolt 39 by being able to be engaged behind by the pulling bolt 39. The pulling surface 49 may in this case be of concave form, that is to say formed inversely with respect to the convex surface of the closing bolt 39. FIG. 4 shows the position as per FIG. 1, in which the coupling element 32 is situated in its initial detent position (passive position) and has not yet been transferred into its coupling position (active position). Thus, in the event of an actuation of the outside door handle 46, the connector 37 and pulling bolt 39 would run into the empty space in the pulling direction Z.

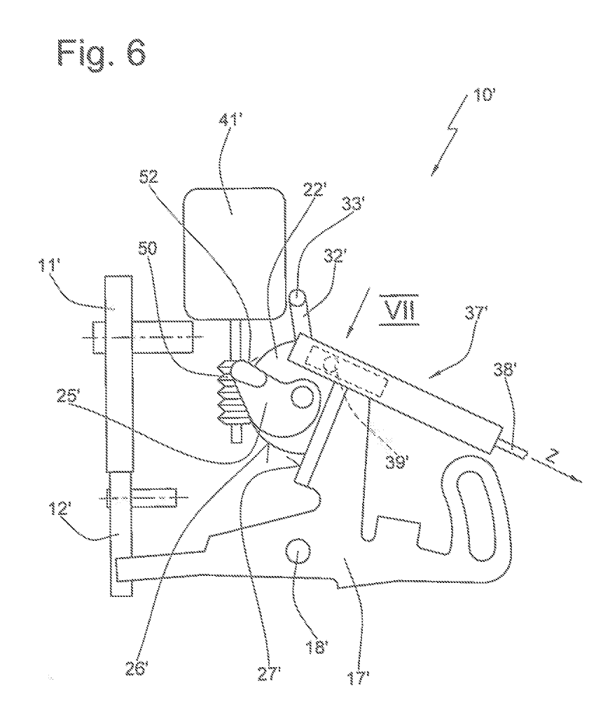

FIG. 6 shows a second exemplary embodiment of a locking device 10′ according to the present invention in a highly schematic plan view. The rotary catch 11′ is, in this case too, arrested by the pawl 12′, into which the pawl lever 17′ engages. The pawl lever 17′ is pivotable about a spindle 18′ and can be actuated at an actuation surface 27′. For the actuation of the pawl lever 17′ before the occurrence of an accident situation, there is basically firstly provided a drive unit 41′ formed as an electric motor, which can act for example via a worm 50 and a worm wheel (not visible in FIG. 6) on a switch element, configured herein, as an output wheel 22′. The output wheel 22′ is coupled in terms of movement to the worm wheel (not illustrated) and follows the movement thereof.

The output wheel 22′ has an eccentric cam 25′ which, by means of an eccentric surface 26′, can engage the actuation surface 27′ on pawl lever 17′ for the purposes of carrying out a conventional opening process of the locking device 10′. For this purpose, the eccentric cam 25′ would be pivoted by the drive unit 41′ through approximately 90 degrees or more in the counterclockwise direction with regard to FIG. 6, which would lead to a pivoting movement of the pawl lever 17′ counterclockwise with regard to FIG. 6 from its home position to its actuated position, whereby the pawl 12′ would be transferred into its releasing position. Here, the pawl 12′ and the rotary catch 11′ typically behave similarly or comparably to their corresponding counterparts in the first exemplary embodiment, and therefore will not be described in any more detail.

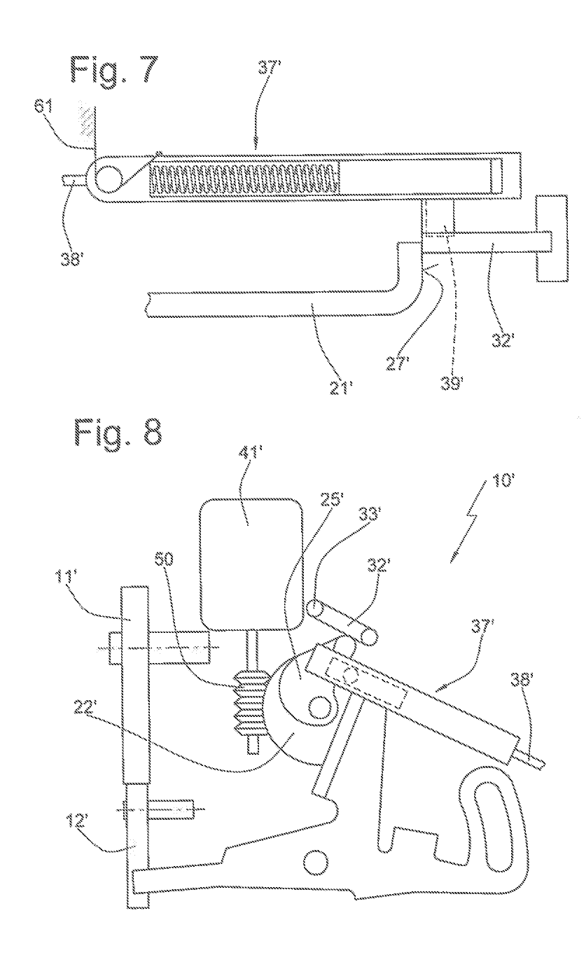

Also visible in FIG. 6 is a coupling element 32′, formed as a one-armed lever, which is pivotable about its pivot spindle 33′. The coupling element 32′ preferably also has two detent positions, one of which is illustrated in FIG. 6. In the illustrated detent position, which can also be referred to as the active position, the coupling element 32′ deflects the connector 37′ of the Bowden cable 38′ upward with regard to the plane of the figure, that is to say toward the viewer, by engaging under the connector 37′. An indicated, the pulling bolt 39′ would, in the event of an actuation of the Bowden cable 38′ (together with housing) for example by means of the outside handle 46 as per FIG. 5, run into an empty space, because the pulling bolt 39′ would pass over the actuation surface 27′ of the pawl lever 17′ without making contact therewith. This is illustrated in FIG. 7 which shows a schematic diagrammatic illustration in a view approximately according to the view arrow VII in FIG. 6, with numerous elements having been omitted.

Thus, the connector 37′ is, in FIG. 7, in a raised and deflected position. The housing surrounding the connector 37′ is in this case attached, so as to be pivotable about its spindle 51, to the mounting plate (not illustrated) of the locking device 10′. The coupling element 32′ however engages under the connector 37′ such that the concealed pulling bolt 39′, which is however illustrated by dashed lines, and the actuation surface 27′ are out of engagement.

In an accident situation, it is however possible, as already described above with regard to the drive unit 41, for the drive unit 41′ to likewise be activated and reversed with regard to its direction of rotation. This has the effect that the eccentric cam 25′ pivots not counterclockwise with regard to FIG. 6, but rather clockwise through approximately 90 degrees from the position illustrated in FIG. 6 into the position illustrated in FIG. 8. Here, the eccentric cam 25′ can act, via a positioning surface 52, on the coupling element 32′ and pivot the coupling element 32′ about its spindle 33′ counterclockwise with regard to the figures into the passive position (also a detent position) illustrated in FIG. 8.

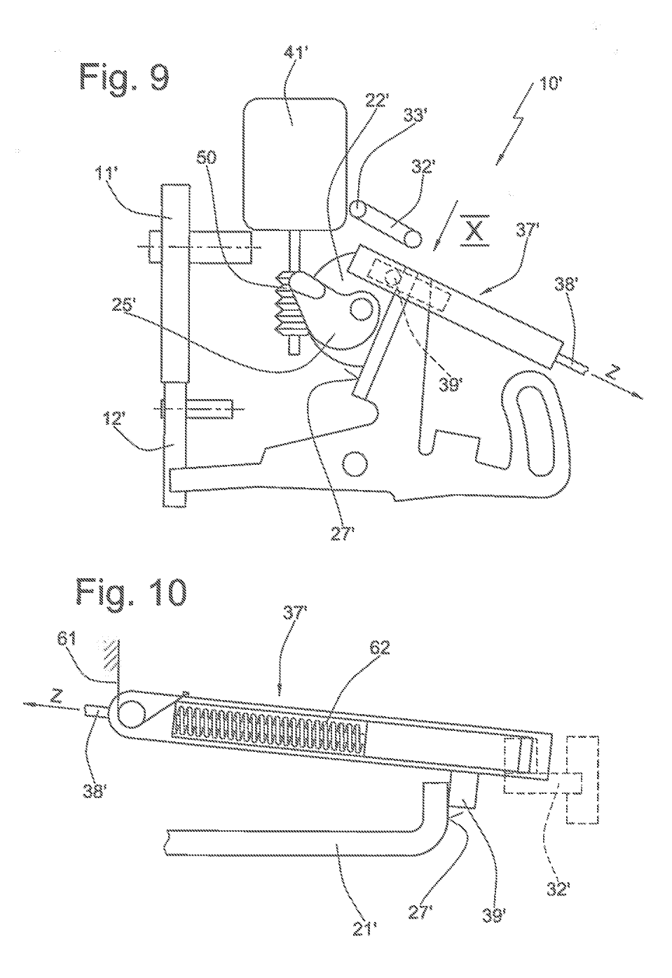

In this position, the coupling element 32′ thus releases the connector 37′, and the latter could theoretically engage. However, in FIG. 8, the eccentric cam 25′ still stands in the way, such that an engagement or coupling does not yet occur in a position as per FIG. 8. Rather, the output wheel 22′ still holds the connector 37′ in a decoupled position. However, the output wheel 22′ is assigned a leg spring which is not additionally illustrated in the figures and which preloads the output wheel 22′ to return back into its initial position. This initial position is illustrated once again in FIG. 9, wherein the eccentric cam 25′ has now also been moved out of the region of the connector 37′. Thus, in FIG. 9, the connector 37′ has engaged and the pulling bolt 39′ thus engages behind the actuation surface 27′ of the pawl lever 17′. An actuation of the outside handle 46 would thus now lead to a displacement of the Bowden cable 38′, the connector 37′ and the pulling bolt 39′ in the pulling direction Z (counter to the spring force of the spring element 62 as per FIG. 10), whereby the pawl lever 17′ would pivot clockwise with regard to FIG. 9 from its home position into its actuated position and cause the pawl 12′ to move from its catch arresting position into its catch releasing position, whereby the rotary catch 11′ would be released.

FIG. 10 illustrates the engaged position as per FIG. 9 approximately along the view arrow X in FIG. 9. The connector 37′ has engaged under the action of a preload imparted by the spring element 61. Here, it can be clearly seen that the pulling bolt 39′ now engages behind the actuation surface 27′ of the pawl lever 17′, whereby a subsequent actuation of the outside handle 46 would lead to a displacement of the pawl lever 17′. In the exemplary embodiment, the connector 37′ engages into an oblique position relative to the pawl lever 17′. In fact, an embodiment which is not illustrated is even more advantageous in which the connector 37′ falls into a parallel position with respect to the lever 17′ (proceeding from an oblique position).

Finally, with regard to the second exemplary embodiment, it is pointed out that certain embodiments that were discussed in detail in conjunction with the first exemplary embodiment have been omitted here. The approach is however basically the same. In both cases, a coupling element is adjustable for the releasably coupling of the connector and the pawl.

Merely for the sake of completeness, it is pointed out once again that, in the claims, the reference designations are stated predominantly without apostrophes, because substantially similar parts are being referred to. Exceptions to this are made in the claims in some cases. In most cases, and where not stated separately, the reference designations are however intended to relate to both embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A locking device for a vehicle door, comprising:
a rotary catch arrested by a pawl for trapping a closing element when the vehicle door is closed,
a drive unit operable in a first powered direction for moving the pawl to release the rotary catch;
a connector operatively connected to an outside door handle of the vehicle door; and
a coupling element which is normally uncoupled from the connector and the pawl and which couples the connector to the pawl in the event of a crash being detected by a crash sensor.

2. The locking device according to claim 1, further comprising means for implementing a signal from the crash sensor, wherein the means act on the coupling element for the purposes of coupling the connector and the pawl and can adjust the coupling element from a passive position into an active position or vice versa.

3. The locking device according to claim 2, wherein the coupling element is moved by the drive unit from a first position whereat the connector is uncoupled from the pawl to a second position whereat the connector is coupled to the pawl, and wherein the drive unit is caused to operate in a second powered direction in response to the signal from the crash sensor for moving the coupling element from its first position into its second position.

4. The locking device according to claim 3, wherein the drive unit has a first state in which it displaces the pawl and a second state in which it adjusts the coupling element, wherein the two states correspond to the two different directions of rotation of an electric motor associated with the drive unit.

5. The locking device according to claim 1, wherein in the event of a manual activation of the outside door handle, the connector runs into free space when the connector and the pawl are decoupled.

6. The locking device according to claim 1, wherein the drive unit acts on a switch element which has a first actuation surface for acting on the pawl and has a second actuation surface for acting on the coupling element.

7. The locking device according to claim 1, wherein the coupling element is assigned a linearly displaceable connecting piece which is adjustable by the coupling element into an opening travel of the connector for the purposes of coupling the connector and the pawl.

8. The locking device according to claim 1, wherein the coupling element actively interrupts the operative chain between the connector and the pawl in a first position by deflecting the connector, and wherein the coupling element can be adjusted into a second position for the purposes of closing the operative chain, whereby the connector is released.

9. The locking device according to claim 1, wherein the coupling element is formed as a one-armed or two-armed lever having two distinct detent positions which correspond in particular to a passive position and an active position.

10. A method for releasing a locking device for a vehicle door comprising:
providing a latch mechanism having a rotary catch which can be arrested by a pawl for trapping a closing element when the vehicle door is closed, wherein the pawl is displaceable, in a non-accident situation, by a powered drive unit for the purposes of releasing the rotary catch, and a connector for a mechanical opening actuation mechanism of the vehicle door including an outside door handle;
detecting an accident situation by means of a crash sensor;
transmitting a signal from the crash sensor to the locking device;
triggering of a coupling element by the powered drive unit in response to the signal from the crash sensor;
coupling of the connector to the pawl by means of the triggered coupling element; and
manually actuating the outside door handle of the mechanical opening actuation mechanism for causing the connector to displace the pawl and release the rotary catch.
